(19) United States
(12) Patent Application Publication
(10) Pub. No.: US 2025/0282133 A1
(43) Pub. Date: Sep. 11, 2025

(54) ELECTRICAL CONNECTIVITY INSPECTION METHOD OF PIEZOELECTRIC ELEMENT, AND MANUFACTURING METHOD OF MAGNETIC HEAD SUSPENSION

(71) Applicant: Suncall Corporation, Kyoto-shi (JP)

(72) Inventors: Yuuya KURACHI, Kyoto-shi (JP); Yasuo FUJIMOTO, Kyoto-shi (JP)

(21) Appl. No.: 18/598,444

(22) Filed: Mar. 7, 2024

(51) Int. Cl. B32B 41/00

(52) U.S. Cl. CPC B32B 41/00; B32B 2457/00

(57) ABSTRACT

The present invention includes an insulation calculation step of calculating, after fixing a piezoelectric element to a predetermined mounting position by a first insulation adhesive, an amount of the first insulation adhesive existing on an inspection area set so as to include a part or all of at least one of a first electrode terminal region and a first electrode connection region, a conduction calculation step of calculating, after electrically connecting the first electrode terminal region to the first electrode connection region by an conductive adhesive, an amount of the conductive adhesive existing on the inspection area and a determination step of determining electrical connectivity between the first electrode and the first electrode connection region on the basis of a difference between calculation values in the conduction calculation step and the insulation calculation step.

### TECHNICAL FIELD

The present invention relates to an inspection method of electrical connectivity of a piezoelectric element, the inspection method being applied in manufacturing a magnetic head suspension including the piezoelectric element that finely moves a gimbal region in a seek direction parallel to a disk surface, and a manufacturing method of the magnetic head suspension.

### BACKGROUND ART

Increase in capacity of a magnetic disk device requires improvement in positioning accuracy of a magnetic head slider with respect to a target track. Thus, a magnetic head suspension that enables coarsely moving of a magnetic head slider in a seek direction by a main actuator such as a voice coil motor, and furthermore, that includes a piezoelectric element acting as a sub actuator and enables finely moving of the magnetic head slider in the seek direction by the piezoelectric element has been proposed (for example, refer to Japanese Unexamined Patent Publication No. 2011-222075 and Japanese Unexamined Patent Publication No. 2013-251018, hereinafter referred to as patent documents 1 and 2, respectively).

More specifically, the magnetic head suspension described in the patent documents 1 and 2 includes a support portion that is directly or indirectly swung about a swing center by the main actuator such as a voice coil motor, a load bending portion having a leaf spring whose proximal end portion is supported by the support portion and which generate a pressing load for pressing the magnetic head slider against a disk surface, a load beam portion that is supported by the support portion via the load bending portion and transmits the pressing load to the magnetic head slider, a flexure portion including a flexure substrate having a gimbal region that supports the magnetic head slider on a lower surface facing the disk surface and with which a dimple provided on the load beam portion is in contact on an upper surface opposite to the disk surface, and a wiring structure fixed to the flexure substrate, and a pair of the piezoelectric elements.

In the magnetic head suspension, the support portion has a proximal-end-side support portion having the swing center, a distal-end-side support portion that supports the proximal end portion of the load bending portion, and a weak-rigidity support portion that connects the distal-end-side support portion and the proximal-end-side support portion such that the distal-end-side support portion can swing to both sides in the seek direction with respect to the proximal-end-side support portion with reference to a suspension longitudinal direction center line. The weak-rigidity support portion has openings in which the pair of piezoelectric elements are arranged.

The pair of piezoelectric elements are arranged in the openings of the weak rigidity support portion in a state of being symmetrical to each other with reference to the suspension longitudinal direction center line and having different expansion and contraction directions from each other, and proximal end sides thereof are fixed to the proximal-end-side support portion by an insulation adhesive and distal end sides thereof are fixed to the distal-end-side support portion by an insulation adhesive.

The piezoelectric element has a piezoelectric body, and first and second electrodes for applying a voltage to the piezoelectric body, which are arranged on the side opposite to the disk surface and on the side closer to the disk surface, respectively.

The second electrode is electrically connected to a wiring in the wiring structure via a conductive adhesive, whereas the first electrode is electrically connected to a predetermined portion of the support portion (the proximal-end-side support portion or the distal-end-side support portion) acting as a ground voltage via a conductive adhesive (hereinafter, referred to as a first electrode conductive adhesive).

In a state of straddling the insulation adhesive for fixing the piezoelectric element to the predetermined portion of the support portion (the proximal-end-side support portion or the distal-end-side support portion) in a bridge shape, the first electrode conductive adhesive electrically connects the first electrode and the support portion (the proximal-end-side support portion or the distal-end-side support portion).

Therefore, after the first electrode conductive adhesive is applied, it is not possible to confirm that the first electrode conductive adhesive electrically connects which region of the first electrode and which region of the predetermined portion of the support portion.

That is, when the insulation adhesive covered with the first electrode conductive adhesive spreads more than necessary beyond a predetermined region to be applied, even if the first electrode conductive adhesive is applied to a predetermined region to be applied, a contact area between the first electrode conductive adhesive and the first electrode and/or the predetermined portion of the support portion becomes small, and in some cases, stable electrical connection may not be obtained.

### SUMMARY OF THE INVENTION

The present invention has been made in view of the prior art, and it is an object of the present invention to provide an inspection method applied to a magnetic head suspension including a piezoelectric element for finely moving a gimbal region in a seek direction parallel to a disk surface, by which electrical connectivity between a first electrode of the piezoelectric element and a first electrode connection region to which the first electrode is electrically connected by a first conductive adhesive can be effectively inspected.

Furthermore, it is an object of the present invention to provide a manufacturing method for a magnetic head suspension including a piezoelectric element for finely moving a gimbal region in a seek direction parallel to a disk surface, the manufacturing method allowing electrical connectivity between a first electrode of the piezoelectric element and a first electrode connection region to which the first electrode is electrically connected by a first conductive adhesive to be effectively recognized.

In order to achieve the object, a first aspect of the present invention provides an inspection method of electrical connectivity of an piezoelectric element, the inspection method being applied in manufacturing a magnetic head suspension including the piezoelectric element that finely moves a gimbal region to which a magnetic head slider is mounted in a seek direction parallel to a disk surface, wherein the piezoelectric element is fixed to a predetermined mounting position by a first insulation adhesive, and wherein a predetermined first electrode terminal region of a first electrode, which is disposed on one side in a thickness direction of the piezoelectric element, is electrically connected to a predetermined first electrode connection region by a first electrode conductive adhesive covering the first insulation adhesive in a bridge-like manner, the inspection method including an insulation calculation step of calculating, after fixing the piezoelectric element to the predetermined mounting position by the first insulation adhesive, an amount of the first insulation adhesive existing on an inspection area set so as to include a part or all of at least one of the first electrode terminal region and the first electrode connection region; a conduction calculation step of calculating, after electrically connecting the first electrode terminal region to the first electrode connection region by the first electrode conductive adhesive, an amount of the first electrode conductive adhesive existing on the inspection area; and a determination step of determining electrical connectivity between the first electrode terminal region and the first electrode connection region on the basis of a difference between a calculation value in the conduction calculation step and a calculation value in the insulation calculation step.

According to the inspection method of the present invention, in the magnetic head suspension that includes the piezoelectric element, which is fixed to the predetermined mounting position by the first insulation adhesive, has the first electrode electrically connected to the predetermined first electrode connection region by the first electrode conductive adhesive, it is possible to effectively inspect electrical connectivity between the first electrode and the first electrode connection region a

For example, the inspection area may be set with reference to a mounting reference point for the piezoelectric element.

In a first embodiment, the insulation calculation step and the conduction calculation step each are configured to calculate a plane area of a portion covered by the corresponding adhesive in the inspection area on the basis of a two-dimensional image of the inspection area captured by a two-dimensional imaging device.

In this case, the determination step is configured to determine the electrical connectivity between the first electrode and the first electrode connection region on the basis of a difference between the plane area of the first electrode conductive adhesive calculated in the conduction calculation step and the plane area of the first insulation adhesive calculated in the insulation calculation step.

In a second embodiment, the insulation calculation step and the conduction calculation step each are configured to calculate a volume of the corresponding adhesive existing on the inspection on the basis of a three-dimensional image of the inspection area captured by a three-dimensional imaging device.

In this case, the determination step is configured to determine the electrical connectivity between the first electrode and the first electrode connection region on the basis of a difference between the volume of the first electrode conductive adhesive calculated in the conduction calculation step and the volume of the first insulation adhesive calculated in the insulation calculation step.

In the first and second embodiments, the insulation calculation step and the conduction calculation step each are preferably configured to perform imaging by the imaging device in a state in which the inspection area was irradiated with ultraviolet light by an ultraviolet irradiation device.

In order to achieve the object, a second aspect of the present invention provides a manufacturing method for a magnetic head suspension including a piezoelectric element that finely moves a gimbal region to which a magnetic head slider is mounted in a seek direction parallel to a disk surface, wherein the piezoelectric element is fixed to a predetermined mounting position by a first insulation adhesive, and wherein a predetermined first electrode terminal region of a first electrode, which is disposed on one side in a thickness direction of the piezoelectric element, is electrically connected to a predetermined first electrode connection region by a first electrode conductive adhesive covering the first insulation adhesive in a bridge-like manner, the manufacturing method including a fixation step of fixing the piezoelectric element to the predetermined mounting position by the first insulation adhesive; an insulation calculation step of calculating an amount of the first insulation adhesive existing on an inspection area set so as to include a part or all of at least one of the first electrode terminal region and the first electrode connection region; a first electrode electrical connection step of applying the first electrode conductive adhesive by a predetermined amount to electrically connect the first electrode terminal region to the first electrode connection; a conduction calculation step of calculating an amount of the first electrode conductive adhesive existing on the inspection area; and a determination step of determining electrical connectivity between the first electrode and the first electrode connection region on the basis of a difference between a calculation value in the conduction calculation step and a calculation value in the insulation calculation step.

According to the manufacturing method of the present invention, since the piezoelectric element is fixed to the predetermined mounting position by the first insulation adhesive, an amount of the first insulation adhesive existing on the inspection area, which is set in such a manner to include a part or all of at least one of the first electrode terminal region and the first electrode connection region, is calculated, the first electrode conductive adhesive is applied to electrically connect the first electrode terminal region to the first electrode connection, an amount of the first electrode conductive adhesive existing on the inspection area is calculated, and electrical connectivity between the first electrode and the first electrode connection region on the basis of a difference between a calculation value of the first electrode conductive adhesive and a calculation value of the first insulation adhesive is determined, it is possible to effectively recognize electrical connectivity between the first electrode and the first electrode connection region in the manufactured magnetic head suspension.

In order to achieve the object, a third aspect of the present invention provides a manufacturing method for a magnetic head suspension including a piezoelectric element that finely moves a gimbal region to which a magnetic head slider is mounted in a seek direction parallel to a disk surface, wherein the piezoelectric element is fixed to a predetermined mounting position by a first insulation adhesive, and wherein a predetermined first electrode terminal region of a first electrode, which is disposed on one side in a thickness direction of the piezoelectric element, is electrically connected to a predetermined first electrode connection region by a first electrode conductive adhesive covering the first insulation adhesive in a bridge-like manner, the manufacturing method including a fixation step of fixing the piezoelectric element to the predetermined mounting position by the first insulation adhesive; an insulation calculation step of calculating an amount of the first insulation adhesive existing on an inspection area set so as to include a part or all of at least one of the first electrode terminal region and the first electrode connection region; an application amount calculation step of calculating an amount of the first electrode conductive adhesive to be applied for electrically connecting the first electrode terminal region to the first electrode connection region, on the basis of the calculation result in the insulation calculation step; and a first electrode electrical connection step of applying the amount of the first electrode conductive adhesive that calculated in the application amount calculation step to electrically connect the first electrode terminal region to the first electrode connection region.

According to the manufacturing method of the present invention, since the piezoelectric element is fixed to the predetermined mounting position by the first insulation adhesive, the amount of the first insulation adhesive existing on the inspection area set so as to include a part or all of at least one of the first electrode terminal region of the piezoelectric element and the first electrode connection region to which the first electrode terminal region is electrically connected is calculated, the amount of the first electrode conductive adhesive to be applied for electrically connecting the first electrode terminal region to the first electrode connection region is calculated on the basis of the calculation result of the first insulation adhesive, and the amount of the first electrode conductive adhesive that is calculated is applied to electrically connect the first electrode terminal region to the first electrode connection region, it is possible to effectively improve the manufacturing yield regarding electrical connectivity between the first electrode and the first electrode connection region.

The manufacturing method of the third aspect of the present invention may preferably include a conduction calculation step of calculating an amount of the first electrode conductive adhesive existing on the inspection area, and a determination step of determining electrical connectivity between the first electrode and the first electrode connection region on the basis of a difference between a calculation value in the conduction calculation step and a calculation value in the insulation calculation step.

In the manufacturing method of the second and third aspects, the calculation steps each are configured to calculate a plane area of a portion covered by the corresponding adhesive in the inspection area on the basis of a two-dimensional image of the inspection area captured by a two-dimensional imaging device.

Alternatively, the calculation steps each may be configured to calculate a volume of the corresponding adhesive existing on the inspection on the basis of a three-dimensional image of the inspection area captured by a three-dimensional imaging device.

The calculation steps are preferably configured to perform imaging by the corresponding imaging device in a state in which the inspection area was irradiated with ultraviolet light by an ultraviolet irradiation device

In a case where the magnetic head suspension includes a support portion that is directly or indirectly swung about a swing center in the seek direction parallel to the disk surface by a main actuator, a load bending portion that includes a leaf spring having a proximal end portion connected to the support portion and generating a load for pressing the gimbal region against the disk surface, a load beam portion that is supported by the support portion via the load bending portion and transmits the load to the gimbal region, and a flexure portion that includes a flexure substrate including the gimbal region and a wiring structure fixed to the flexure substrate; the support portion includes a proximal-end-side support portion having the swing center, a distal-end-side support portion that supporting the proximal end side of the load bending portion, and a weak rigidity support portion connecting the distal-end-side support portion and the proximal-end-side support portion such that the distal-end-side support portion can swing to both sides in the seek direction with respect to the proximal-end-side support portion with reference to a suspension longitudinal direction center line, the weak-rigidity support portion being provided with openings that enable the pair of piezoelectric elements to be arranged symmetrically to each other with respect to the longitudinal direction center line; the magnetic head suspension further includes a support plate fixed to a lower surface of the support portion, the support plate supporting the lower surfaces of the pair of piezoelectric elements while having access openings for exposing parts of lower surfaces of the pair of piezoelectric elements to the disk surface side; the wiring structure includes an insulation layer provided on the lower surface of the flexure substrate that faces the disk surface, and a conductor layer provided on the insulation layer; the insulation layer has an extension region extending into the access opening in planar view; the conductor layer includes a signal wiring electrically connected to the magnetic head slider and a piezoelectric element wiring for supplying a driving voltage to the piezoelectric element, the piezoelectric element wiring having has a piezoelectric element terminal region arranged in the extension region; and a second electrode of the piezoelectric element that is disposed on the other side in the thickness direction of the piezoelectric element is electrically connected to the piezoelectric element terminal region via a second electrode conductive adhesive filled in the access opening and a through hole formed in the extension region, the manufacturing method according to any one of various configurations of the second and third aspects includes a temporary fixation step performed before the fixation step, the temporary fixation step is configured to apply the second electrode conductive adhesive in the access opening and the through hole and apply a second insulation adhesive for temporary fixation to the support plate, and then mount the piezoelectric element such that the second electrode of the piezoelectric element is in contact with the second electrode conductive adhesive and a peripheral region of the lower surface of the piezoelectric element is in contact with the second insulation adhesive for temporary fixation.

In this case, wherein the fixation step is configured to apply the first insulation adhesive in gaps between the piezoelectric element and the proximal-end-side support portion, the distal-end-side support portion and the weak rigidity support portion, and the inspection area is set at the first electrode the support portion.

In a case where the magnetic head suspension includes a support portion that is directly or indirectly swung about a swing center in the seek direction parallel to the disk surface by a main actuator, a load bending portion that includes a leaf spring having a proximal end portion connected to the support portion and generating a load for pressing the gimbal region against the disk surface, a load beam portion that is supported by the support portion via the load bending portion and transmits the load to the gimbal region, and a flexure portion that includes a flexure substrate including the gimbal region and a wiring structure fixed to the flexure substrate; the flexure substrate includes a load-beam-portion fixation region overlapped with and fixed to the load beam portion, and a flexure distal end region extending from the load-beam-portion fixation region to the distal end side so as to be free from a state of being supported by the load beam portion; the flexure distal end region has the gimbal region and a pair of gimbal support pieces, the gimbal region having an upper surface opposite to the disk surface with which the dimple provided in the load beam portion is in contact and a lower surface facing the disk surface that supports the magnetic head slider, the pair of gimbal support pieces extending from the load-beam-portion fixation region toward the distal end side in the suspension longitudinal direction in a state of being symmetrical to each other with reference to the suspension longitudinal direction center line and supporting the gimbal region such that the gimbal region can swing in a roll direction and the seek direction with the dimple as a fulcrum; the gimbal region and the pair of gimbal support pieces are configured to form openings that enable the pair of piezoelectric elements to be arranged symmetrically to each other with respect to the suspension longitudinal direction center line; the gimbal region is provided with a weak rigidity portion that enables the gimbal region to swing to both sides in the seek direction with the dimple as a fulcrum in response to expansion and contraction operation of the pair of piezoelectric elements; the wiring structure includes an insulation layer provided on the lower surface of the flexure substrate that faces the disk surface, and a conductor layer provided on a lower surface of the insulation layer; the insulation layer has an air region that is away from a state of being supported by the flexure substrate and extends into the opening; the conductor layer includes a signal wiring electrically connected to the magnetic head slider and a piezoelectric element wiring for supplying a driving voltage to the piezoelectric element; the piezoelectric element wiring has a piezoelectric element terminal region arranged in the air region; the wiring structure further includes a ground metallic portion provided on the lower surface of the air region in a state of being insulated from the conductor layer; the air region has a first electrode through hole and a second electrode through hole that cause the piezoelectric element terminal region and the ground metallic portion to be exposed to the upper surface of the insulation layer, respectively; a region of the piezoelectric element terminal region that is exposed via the first electrode through hole forms the first electrode connection region; and a second electrode of the piezoelectric element that is disposed on the other side in the thickness direction of the piezoelectric element is electrically connected to the ground metallic portion via a second electrode conductive adhesive filled in the second electrode through hole, the manufacturing method according to any one of various configurations of the second and third aspects further includes a second electrode electrical connection step performed in parallel with the fixation step and a piezoelectric element second end portion fixation step performed at an appropriate timing after the second electrode electrical connection step.

The fixation step and the second electrode electrical connection step that are performed in parallel are configured so as to apply the first insulation adhesive to an area of the upper surface of the air region on which a first end portion in the longitudinal direction of the piezoelectric element is mounted and apply the second electrode conductive adhesive in the second electrode through hole, and then mount the piezoelectric element on the upper surface of the air region so that the first end portion of the piezoelectric element is fixed to the upper surface of the air region while the second electrode is electrically connected to the ground conductive region.

The piezoelectric element second end portion fixation step is configured so as to fix a second end portion in the longitudinal direction of the piezoelectric element to the gimbal region by another second insulation adhesive.

In this case, the inspection area is set to the region of the piezoelectric element terminal region that is exposed via the first electrode through hole.

### BRIEF DESCRIPTION OF THE DRAWINGS

FIG. 1 is a plan view of a magnetic head suspension manufactured by a manufacturing method according to one embodiment of the present invention.

FIG. 2 is a bottom view of the magnetic head suspension.

FIG. 3 is a plan view of main components in the magnetic head suspension in a single state.

FIG. 4 is an enlarged view of a portion IV in FIG. 1.

FIG. 5 is a schematic cross-sectional view along a line V-V in FIG. 4.

FIGS. 6A and 6B are a plan view and a bottom view of a preassembly obtained by fixing a support portion and a rigid plate in the magnetic head suspension, respectively.

FIG. 7 is an enlarged view of a portion VII in FIG. 2.

FIG. 8 is an enlarged view of a portion VIII in FIG. 1.

FIG. 9 is a plan view, which corresponds to FIG. 4, of a state in which a first electrode conductive adhesive is omitted from FIG. 4.

FIG. 10 is a plan view, which corresponds to FIG. 4, of a state in which the first insulation adhesive and a first electrode conductive adhesive are omitted from FIG. 4.

FIG. 11 is a plan view, which corresponds to FIG. 9, of an example in which the first insulation adhesive is excessively applied.

FIG. 12 is a plan view, which corresponds to FIG. 4, of a state in which the first electrode conductive adhesive, a support-portion-directed piezoelectric element and the first insulation adhesive are omitted from FIG. 4.

FIG. 13 is a cross-sectional view along a line XIII-XIII in FIG. 12.

FIG. 14 is a cross-sectional view, which corresponds to FIG. 13, showing a halfway state of a temporary fixation step for temporarily fixing the support-portion-directed piezoelectric element in the magnetic head suspension.

FIG. 15 is a cross-sectional view, which corresponds to FIG. 13, showing a completion state of the temporary fixation.

FIG. 16 is a plan view, which corresponds to FIG. 8, of a state in which a load beam portion is omitted.

FIG. 17 is a cross-sectional view along a line XVII-XVII in FIG. 16.

FIG. 18 is a plan view, which corresponds to FIG. 16, of a state in which a flexure-portion-directed piezoelectric elements are omitted.

FIG. 19 is a cross-sectional view along a line XIX-XIX in FIG. 18.

FIG. 20 is a cross-sectional view, which corresponds to FIG. 19, of a halfway state a fixation step and a second electrode electrical connection step which are performed in parallel at the time when the flexure-portion-directed piezoelectric elements are fixed.

FIG. 21 is a plan view, which corresponds to FIGS. 16 and 18, of a state in which the fixation step and the second electrode electrical connection step have been completed.

FIG. 22 is a cross-sectional view along a line XXII-XXII in FIG. 21.

### DETAILED DESCRIPTION OF THE PREFERRED EMBODIMENTS

Hereinafter, an embodiment of a manufacturing method for a magnetic head suspension according to the present invention will be described with reference to the accompanying drawings.

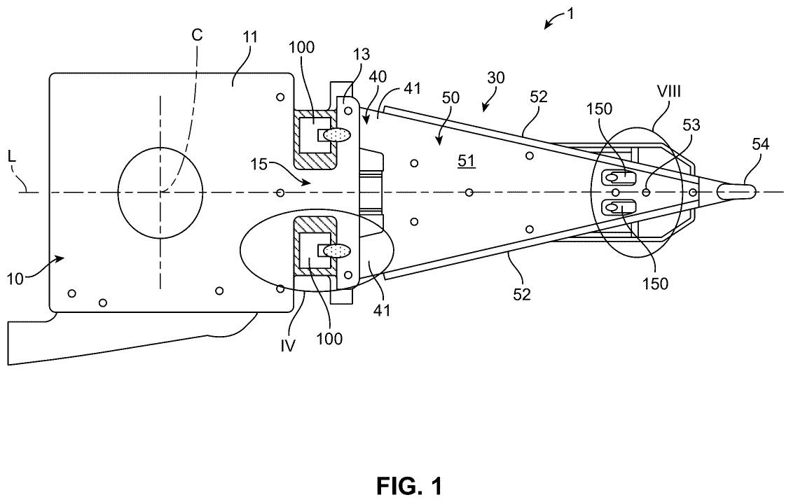

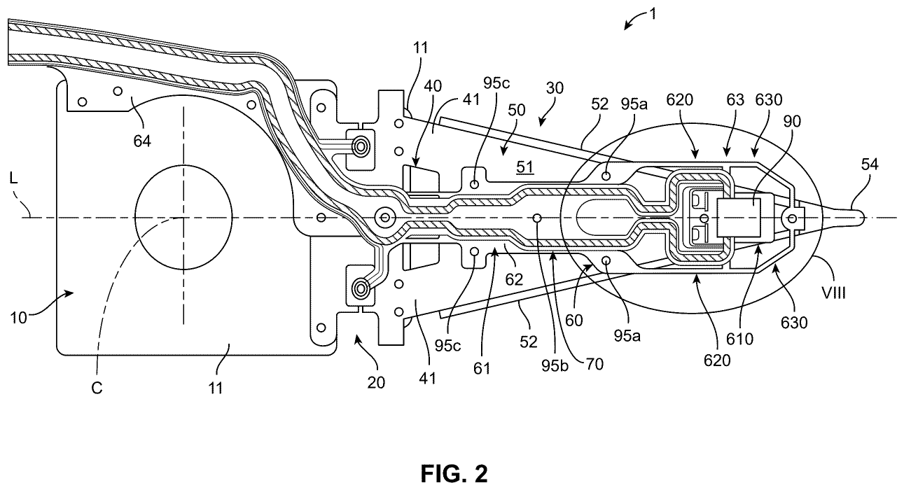

FIGS. 1 and 2 illustrate a plan view (a view seen from a side opposite to a disk surface) and a bottom view (a view seen from the disk surface) of a magnetic head suspension 1 manufactured by a manufacturing method according to the present embodiment, respectively.

A small circle (∘) in FIGS. 1 and 2 indicates a welding point.

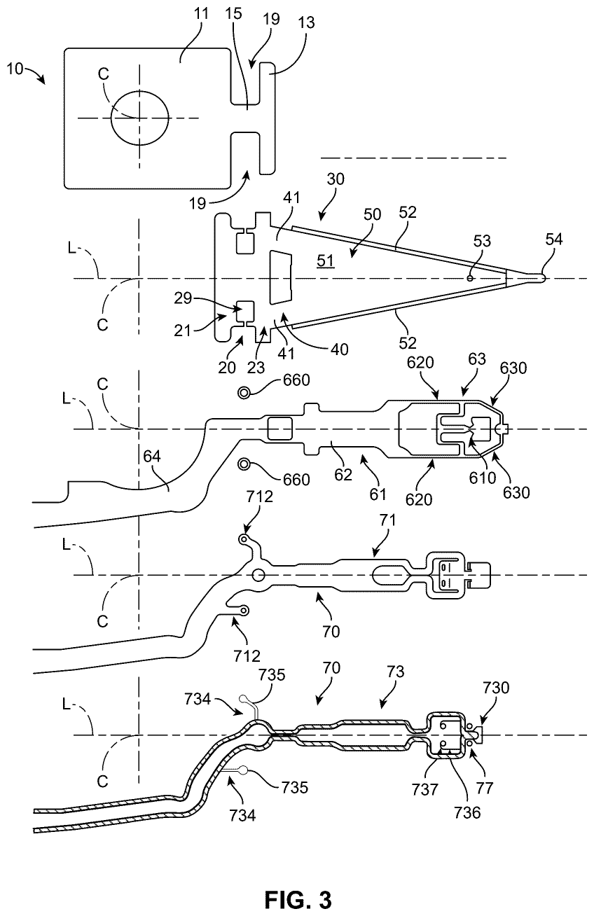

FIG. 3 illustrates a plan view (a view seen from the side opposite to the disk surface) of main components in the magnetic head suspension in a single state.

As illustrated in FIGS. 1 to 3, the magnetic head suspension 1 includes a support portion 10 that is directly or indirectly swung about a swing center C in a seek direction parallel to the disk surface by a main actuator such as a voice coil motor (not illustrated), a load bending portion 40 that includes a leaf spring 41 whose proximal end portion is connected to the support portion 10 so as to generate a load for pressing a magnetic head slider 90 against the disk surface, a load beam portion 50 that is supported by the support portion 10 via the leaf spring 41 and transmits the load to the magnetic head slider 90, and a flexure portion 60 that is supported by the load beam portion 50 and supports the magnetic head slider 90 in a gimbal region 610 provided on the distal end side.

The support portion 10 is a member that supports the load beam portion 50 via the leaf spring 41 in a state of being directly or indirectly connected to the main actuator, and has relatively high rigidity.

The support portion 10 is preferably formed of, for example, a stainless-steel plate having a thickness of 0.1 mm to 0.8 mm.

In the magnetic head suspension 1, as illustrated in FIGS. 1 to 3, the support portion 10 is a base plate including a boss portion to be joined by caulking to the distal end of a carriage arm (not illustrated) connected to the main actuator.

As a matter of course, as the support portion 10, an arm whose proximal end portion is connected to a swing center C of the main actuator may be employed.

The support portion 10 has a proximal-end-side support portion 11 having the swing center C, a distal-end-side support portion 13 that supports the proximal end side of the load bending portion 40, and a weak-rigidity support portion 15 that connects the distal-end-side support portion 13 and the proximal-end-side support portion 11.

The weak rigidity support portion 15 connects the distal-end-side support portion 13 and the proximal-end-side support portion 11 such that the distal-end-side support portion 13 can swing to both sides in the seek direction with respect to the proximal-end-side support portion 11 with reference to a suspension longitudinal direction center line (hereinafter, referred to as a longitudinal direction center line L).

The magnetic head suspension 1 is configured so as to coarsely move the gimbal region 610 (the magnetic head slider 90) in the seek direction by the main actuator, and also finely move the gimbal region 610 (the magnetic head slider 90) in the seek direction by a sub actuator.

Specifically, the magnetic head suspension 1 further has a pair of support-portion-directed piezoelectric elements 100 that act as the sub actuator.

The pair of support-portion-directed piezoelectric elements 100 are arranged such that the distal-end-side support portion 13 swings to both sides in the seek direction with respect to the proximal-end-side support portion 11 with reference to the longitudinal direction center line L in response to voltage application.

More specifically, as illustrated in FIG. 3, the weak-rigidity support portion 15 is arranged on the longitudinal direction center line L, and has openings 19 that enable the pair of support-portion-directed piezoelectric elements 100 to be arranged symmetrically to each other with respect to the longitudinal direction center line L.

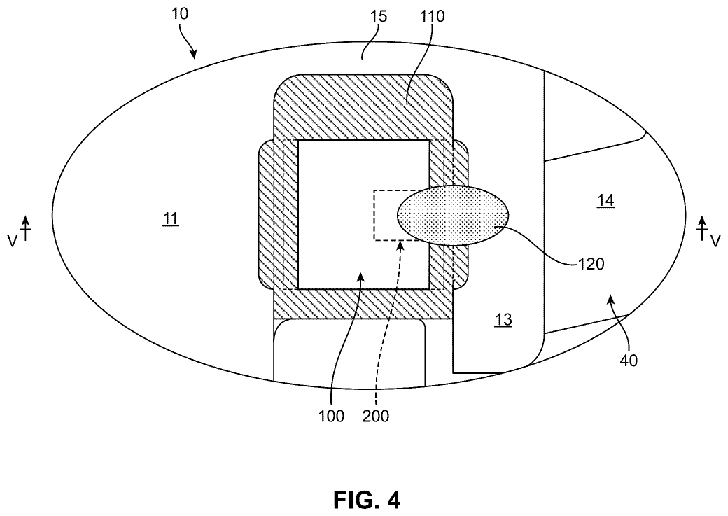

FIG. 4 illustrates an enlarged view of a portion IV in FIG. 1.

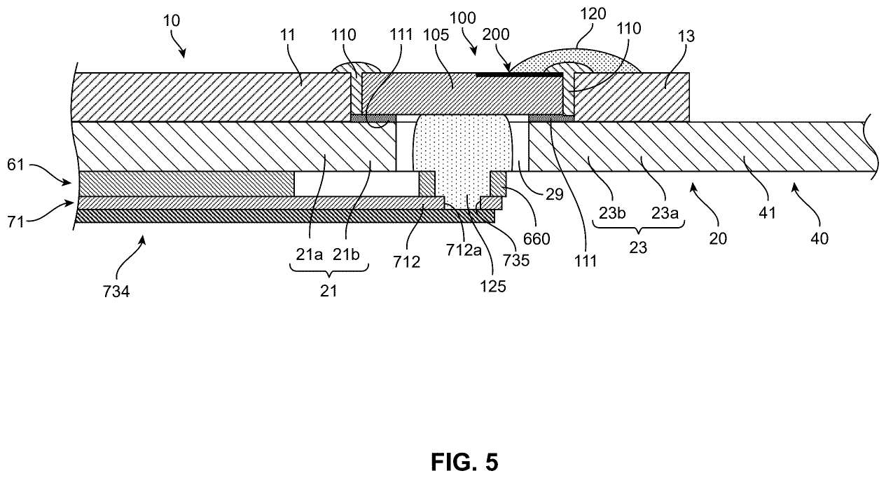

Moreover, FIG. 5 illustrates a schematic cross-sectional view along a line V-V in FIG. 4.

As illustrated in FIGS. 3 and 5, the magnetic head suspension 1 further has a support plate 20 that supports the lower surfaces of the pair of support-portion-directed piezoelectric elements 100 while having access openings 29 for exposing a part of lower surfaces (surfaces that face the disk surface) of the pair of support-portion directed piezoelectric elements 100 to the disk surface side.

In the magnetic head suspension 1, as illustrated in FIGS. 2 and 3, the load beam portion 50 and the load bending portion 40 are formed of a single rigid plate 30, and the support plate 20 is also integrally formed of the rigid plate 30.

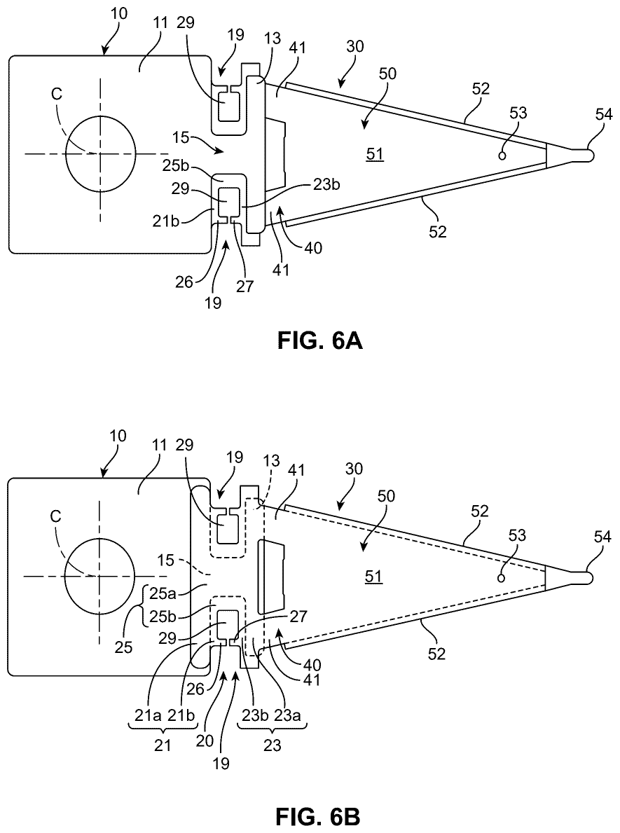

FIGS. 6A and 6B illustrate a plan view (a view seen from the side opposite to the disk surface) and a bottom view (a view seen from the side of the disk surface) of a preassembly obtained by fixing the support portion 10 and the rigid plate 30, respectively.

The support plate 20 is fixed to a lower surface (a surface that faces the disk surface) of the support portion 10.

More specifically, as illustrated in FIGS. 6A and 6B, the support plate 20 has a proximal-end-side plate portion 21 including a proximal-end-side fixation region 21a overlapped with and fixed to a lower surface of the proximal-end-side support portion 11 and a proximal-end-side extension region 21b extending from the proximal-end-side fixation region 21a into the opening 19, and a distal-end-side plate portion 23 including a distal-end-side fixation region 23a overlapped with and fixed to a lower surface of the distal-end-side support portion 13 and a distal-end-side extension region 23b extending from the distal-end-side fixation region 23a into the opening 19. The access opening 29 is arranged between the proximal-end-side extension region 21b and the distal-end-side extension region 23b with reference to the longitudinal direction of the magnetic head suspension 1.

In the magnetic head suspension 1, the support plate 20 further has an intermediate plate portion 25 including an intermediate fixation region 25a overlapped with and fixed to a lower surface of the weak-rigidity support portion 15 and an intermediate extension region 25b extending from the intermediate fixation region 25a into the opening 19.

The support plate 20 further has a proximal-end-side piece 26 that is arranged on the outer side in a suspension width direction with respect to a mounting position of the support-portion-directed piezoelectric element 100 and extends from the proximal-end-side plate portion 21 toward the distal end side, and a distal-end-side piece 27 that is arranged on the outer side in the suspension width direction with respect to the mounting position of the support-portion-directed piezoelectric element 100 and extends from the distal-end-side plate portion 23 to the proximal end side. The proximal-end-side piece 26 and the distal-end-side piece 27 face each other with a slit therebetween.

The load beam portion 50 is a member for transmitting a load generated by the leaf spring 41 to the gimbal region 610, and thus requires predetermined rigidity.

As illustrated in FIGS. 1 to 3 and the like, the load beam portion 50 has a plate-like main body portion 51 that faces the disk surface, and a pair of left and right flange portions 52 extending from both sides of the main body portion 51 in the suspension width direction in a direction opposite to the disk surface. The rigidity is improved by the flange portions 52. The load beam portion 50 is preferably formed of, for example, a stainless-steel plate having a thickness of 0.02 mm to 0.1 mm.

As illustrated in FIGS. 1 and 3, the load beam portion 50 further has a projection called a dimple 53 arranged on the suspension longitudinal direction center line L on the distal end side of the main body portion 51.

The dimple 53 protrudes in a direction closer to the disk surface, for example, by about 0.05 mm to 0.1 mm. The dimple 53 comes into contact with an upper surface (a rear surface opposite to a support surface that supports the magnetic head slider 90) of the gimbal region (head mounting region) 610 of the flexure portion 60, and the load is transmitted to the gimbal region 610 through the dimple 53.

In the magnetic head suspension 1, as illustrated in FIGS. 1 to 3 and the like, the load beam portion 50 further integrally has a lift tab 54 extending from the distal end of the main body portion 51 toward the distal end side in the suspension longitudinal direction. The lift tab 54 is a member for, when the magnetic head suspension 1 is swung by the main actuator such that the magnetic head slider 90 is located outward in a radial direction of the disk surface, separating the magnetic head slider 90 from the disk surface along a z-direction perpendicular to the disk surface by engaging with a ramp provided in a magnetic disk device.

In the magnetic head suspension 1, as illustrated in FIGS. 1 to 3 and the like, both sides of the main body portion 51 of the load beam portion 50 in the suspension width direction are inclined substantially linearly so as to come close to the suspension longitudinal direction center line L from the proximal end side toward the distal end side in the suspension longitudinal direction.

According to such a configuration, the moment of inertia about the center line L on the distal end side of the load beam portion 50 can be reduced, and the resonance frequencies in a torsion mode and a sway mode can be increased.

In the magnetic head suspension 1, the load beam portion 50 is bent about a load beam portion bending line (not illustrated) along the suspension width direction in a direction in which the distal end side is separated from the disk surface.

By adjusting a bending angle at the load beam portion bending line, the positional deviation (gain) of the magnetic head slider 90 in a vibration of a torsion mode (particularly, a first torsion mode having a lowest resonance frequency among torsion modes can be reduced.

The leaf spring 41 has the proximal end portion connected to the distal end side of the support portion 10 and the distal end portion connected to the proximal end portion of the load beam portion 50 in a state in which the plate surface of the leaf spring 41 faces the disk surface.

The leaf spring 41 is bent about a load bending line (not illustrated) in a direction in which the distal end side of the load beam portion 50 comes closer to the disk surface. The magnetic head suspension 1 is incorporated in a hard disk device in a state in which the leaf spring 41 is bent back by a predetermined amount about the load bending line so as to have retained elasticity.

More specifically, when the hard disk device is in an operating condition and the disk surface is rotated, the magnetic head slider 90 floats in a direction separated from the disk surface by receiving air pressure caused by the rotation of the disk surface, and the leaf spring 41 is further elastically deformed in the direction in which the leaf spring 41 is bent back in response to the floating operation of the magnetic head slider 90, thereby increasing the retained elasticity.

That is, the retained elasticity generated in the leaf spring 41 due to the elastic deformation of the leaf spring 41 when the magnetic head suspension 1 is incorporated in the hard disk device and the elastic deformation of the leaf spring 41 due to the floating operation of the magnetic head slider 90 caused by the rotation of the disk surface acts as a pressing load for pressing the magnetic head slider 90 against the disk surface.

The leaf spring 41 is formed of, for example, a stainless steel plate having a thickness of 0.02 mm to 0.1 mm.

As described above, in the magnetic head suspension 1, the leaf spring 41 is integrally formed of the rigid plate 30 together with the load beam portion 50 and the support plate 20.

The flexure portion 60 is fixed to the load beam portion 50 in a state of supporting the magnetic head slider 90 at the gimbal region 610.

More specifically, the flexure portion 60 has a flexure substrate 61 including the gimbal region 610, and a wiring structure 70 fixed to the flexure substrate 61.

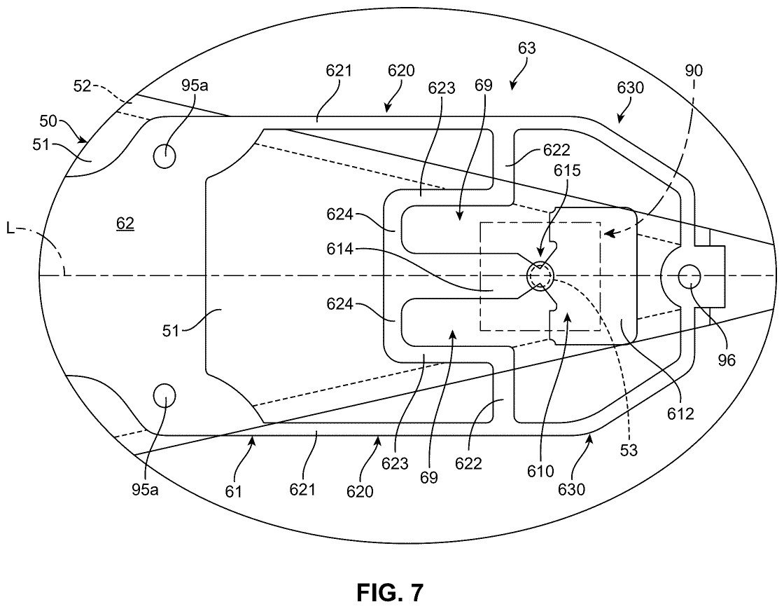

FIG. 7 illustrates an enlarged view of a portion VII in FIG. 2.

In order to facilitate understanding of the flexure substrate 61, the wiring structure 70 is omitted and the magnetic head slider 90 is indicated by the dash-double-dot line in FIG. 7.

As illustrated in FIGS. 2, 3, and 7, the flexure substrate 61 has a load-beam-portion fixation region 62 overlapped with and fixed by welding to a lower surface (a surface facing the disk) of the main body portion 51 of the load beam portion 50, and a flexure distal end region 63 extending from the load-beam-portion fixation region 62 to the distal end side.

As illustrated in FIG. 2, the load-beam-portion fixation region 62 is fixed to the main body portion 51 by spot welding at welding points 95 arranged symmetrically with reference to the suspension longitudinal direction center line L.

In the magnetic head suspension 1, as illustrated in FIG. 2, the load-beam-portion fixation region 62 is welded to the main body portion 51 of the load beam portion 50 at a pair of distal-end-side welding points 95a arranged symmetrically to each other with reference to the suspension longitudinal direction center line L on the distal end side, a pair of proximal-end-side welding points 95c arranged symmetrically to each other with reference to the suspension longitudinal direction center line L on the proximal end side, and an intermediate welding point 95b arranged on the suspension longitudinal direction center line L between the distal-end-side welding points 95a and the proximal-end-side welding points 95c with reference to the suspension longitudinal direction.

The flexure substrate 61 further has a support-portion fixation region 64 extending from the load-beam-portion fixation region 62 to the proximal end side and fixed to the lower surface of the support portion 10.

The support-portion fixation region 64 is fixed to the lower surface of the support portion 10 by spot welding at multiple welding points.

The flexure distal end region 63 has the gimbal region 610, and a pair of gimbal support pieces 620 that extend from the load-beam-portion fixation region 62 to the distal end side in the suspension longitudinal direction in a state of being symmetrical to each other with reference to the suspension longitudinal direction center line L and support the gimbal region 610.

The gimbal region 610 has the upper surface (the surface opposite to the disk surface) with which the dimple provided in the load beam portion 50 is in contact, and the lower surface (the surface that faces the disk surface) that supports the magnetic head slider 90.

The gimbal support pieces 620 support the gimbal region 610 such that the gimbal region 610 can swing in a roll direction and the seek direction with the dimple 53 as a fulcrum.

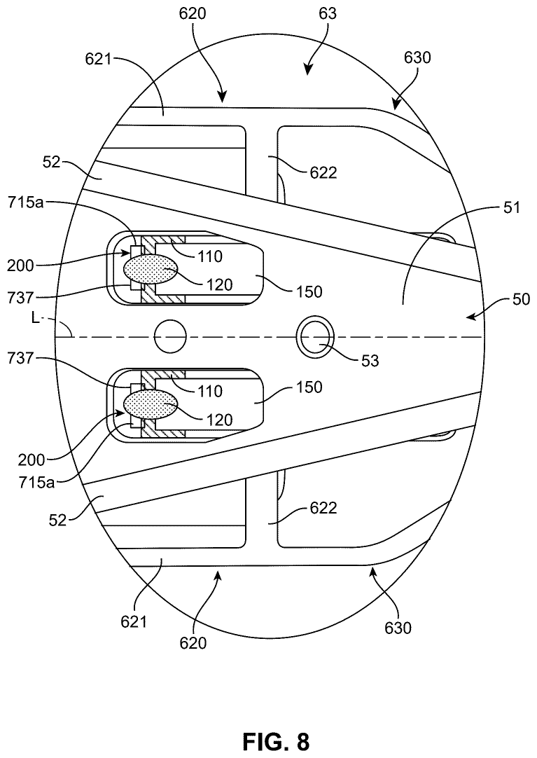

FIG. 8 illustrates an enlarged view of a portion VIII in FIG. 1.

As illustrated in FIGS. 1 and 8, the magnetic head suspension 1 further has a pair of flexure-portion-directed piezoelectric elements 150 that act as the sub actuator.

More specifically, as illustrated in FIG. 7, the gimbal region 610 and the pair of gimbal support pieces 620 are configured to form openings 69 that enable the pair of flexure-portion-directed piezoelectric elements 150 to be arranged symmetrically to each other with respect to the suspension longitudinal direction center line L.

In the magnetic head suspension 1, as illustrated in FIG. 7, the gimbal region 610 has a wide portion 612 located on the distal end side in the suspension longitudinal direction, and a narrow portion 614 extending from the wide portion 612 to the proximal end side in the suspension longitudinal direction with the distal end side connected to the wide portion 612.

As illustrated in FIG. 7, the gimbal support piece 620 has a distal-end-direction extension portion 621 extending from the load-beam-portion fixation region 62 to the distal end side in the suspension longitudinal direction, a distal-end-side width-direction extension portion 622 extending from the distal-end-direction extension portion 621 to the inner side in the suspension width direction, a proximal-end-direction extension portion 623 extending from the distal-end-side width-direction extension portion 622 to the proximal end side in the suspension longitudinal direction, and a proximal-end-side width-direction extension portion 624 extending from the proximal-end-direction extension portion 623 to the inner side in the suspension width direction and connected to the proximal end side of the narrow portion 614.

In planar view, a space surrounded by the wide portion 612, the narrow portion 614, the proximal-end-side width-direction extension portion 624, and the proximal-end-direction extension portion 623 forms the opening 69 that enables the flexure-portion-directed piezoelectric element 150 to be mounted.

Furthermore, in the magnetic head suspension 1, the gimbal region 610 is provided with a weak rigidity portion 615 that enables the gimbal region 610 to swing to both sides in the seek direction with the dimple 53 as a fulcrum by expansion and contraction operation of the pair of flexure-portion-directed piezoelectric elements 150. As illustrated in FIG. 7, notches that are provided in the narrow portion 614 and open outward in the suspension width direction form the weak rigidity portion 615.

As illustrated in FIG. 7, the flexure substrate 61 has a pair of distal-end-side support pieces 630 that extend from the distal-end-direction extension portions 621 of the pair of gimbal support pieces 620 to the distal end side in the suspension longitudinal direction and are connected to each other on the distal end side in the suspension longitudinal direction with respect to the gimbal region 610.

The pair of distal-end-side support pieces 630 are fixed to the load beam portion 50 by spot welding at a welding point 96 (refer to FIG. 7) on the suspension longitudinal direction center line L.

The flexure substrate 61 has lower rigidity than the load beam portion 50 such that the gimbal region 610 can swing in the roll direction and a pitch direction.

The flexure substrate 61 is preferably formed of, for example, a metallic material, such as stainless steel, having a thickness of about 0.01 mm to 0.025 mm.

As illustrated in FIG. 3 and the like, the wiring structure 70 has an insulation layer 71 of polyimide or the like fixed to a lower surface of the flexure substrate 61, which faces the disk surface, and a conductor layer 73 of Cu or the like provided on a lower surface of the insulation layer 71.

The conductor layer 73 has signal wiring 730 electrically connected to the magnetic head slider 90 and piezoelectric element wiring for supplying a driving voltage to the piezoelectric elements 100 and 150.

As described above, the magnetic head suspension 1 has the pair of support-portion-directed piezoelectric elements 100 and the pair of flexure-portion-directed piezoelectric elements 150 as the sub actuator.

Therefore, as illustrated in FIG. 3, the conductor layer 73 has a wiring 734 for support-portion directed piezoelectric element and a wiring 736 for flexure-portion-directed piezoelectric element as the piezoelectric element wiring.

Hereinafter, a manufacturing method for the magnetic head suspension 1 will be described.

As described above, the magnetic head suspension 1 has the pair of support-portion-directed piezoelectric elements 100 and the pair of flexure-portion-directed piezoelectric elements 150, and thus the manufacturing method includes processing of fixing the support-portion-directed piezoelectric elements 100 to a predetermined position while electrically connecting the support-portion-directed piezoelectric elements 100 to the wiring 734 for support-portion-directed piezoelectric element (hereinafter referred to as support-portion directed piezoelectric element fixation processing), and processing of fixing the flexure-portion-directed piezoelectric elements 150 to a predetermined position while electrically connecting the flexure-portion-directed piezoelectric elements 150 to the wiring 736 for flexure-portion-directed piezoelectric element (hereinafter referred to as flexure-portion-directed piezoelectric element fixation processing).

First, the support-portion-directed piezoelectric element fixation processing will be described.

As illustrated in FIG. 5, the support-portion-directed piezoelectric element 100 has a piezoelectric body 105, and first and second electrodes (not illustrated) for applying a voltage to the piezoelectric body 105, which are disposed on one side and the other side in a thickness direction of the piezoelectric body 105, respectively.

As illustrated in FIGS. 4 and 5, in a state in which the support-portion-directed piezoelectric element 100 is fixed to a predetermined mounting position by a first insulation adhesive 110, a predetermined first electrode terminal region of the first electrode is electrically connected to a predetermined first electrode connection region by a first electrode conductive adhesive 120, and the second electrode is electrically connected to a predetermined second electrode connection region by a second electrode conductive adhesive 125.

As illustrated in FIGS. 4 to 6, in the magnetic head suspension 1, in a state in which the support-portion-directed piezoelectric element 100 is fixed to an upper surface (a surface opposite to a magnetic disk) of the proximal-end-side extension region 21b, the distal-end-side extension region 23b, and the intermediate extension region 25b by the first insulation adhesive 110, the first electrode located on the upper surface side opposite to the magnetic disk is electrically connected to an upper surface (a surface opposite to the magnetic disk) of the support portion 10 by the first electrode conductive adhesive 120, and the second electrode located on the lower surface side closer to the magnetic disk is electrically connected to the wiring 734 for support-portion-directed piezoelectric element by the second electrode conductive adhesive 125.

That is, in the magnetic head suspension 1, in a state in which the first electrode of the support-portion-directed piezoelectric element 100 is electrically connected to the upper surface of the support portion 10 so as to be set to a ground voltage, a predetermined voltage is applied to the second electrode via the wiring 734 for support-portion-directed piezoelectric element, so that the support-portion-directed piezoelectric element 100 performs expansion and contraction operation.

A predetermined amount of each of the adhesives 110 and 120 is discharged by a discharging device such as a dispenser.

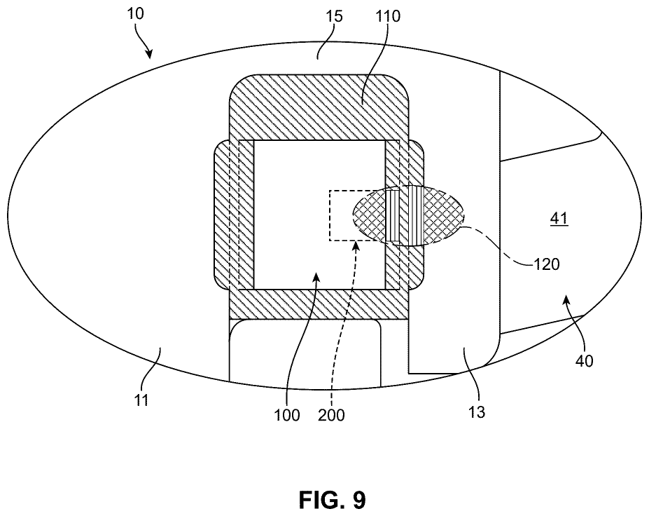

FIG. 9 illustrates a plan view, which corresponds to FIG. 4, of a state in which the first electrode conductive adhesive 120 is omitted from FIG. 4.

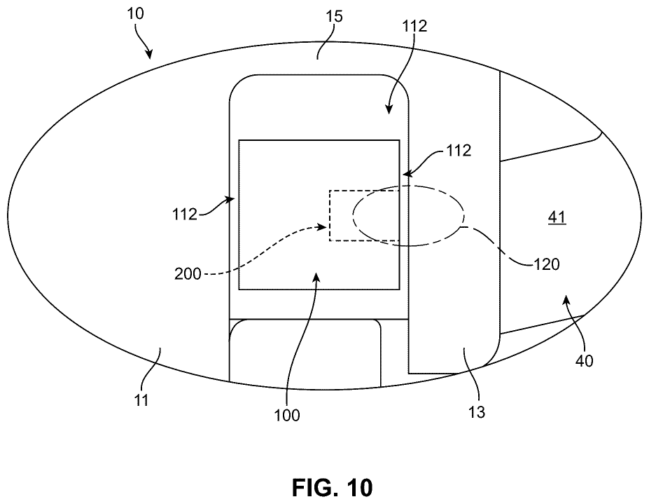

Moreover, FIG. 10 illustrates a plan view, which corresponds to FIG. 4, of a state in which the first insulation adhesive 110 and the first electrode conductive adhesive 120 are omitted from FIG. 4.

In FIGS. 9 and 10, an outer shape of the first electrode conductive adhesive 120 in planar view is indicated by the dash-double-dot line.

In the present embodiment, as illustrated in FIG. 10, a predetermined region set in advance on the upper surface of the support portion 10 is used as the first electrode connection region.

As described above, in the structure in which the first electrode connection region is provided on the upper surface of the support portion 10, the following problem may occur with respect to electrical connection between a predetermined first electrode terminal region in the first electrode of the support-portion-directed piezoelectric element 100 and the first electrode connection region.

That is, as illustrated in FIGS. 4 and 5, the first electrode conductive adhesive 120 for electrically connecting the predetermined first electrode terminal region in the first electrode of the support-portion-directed piezoelectric element 100 and the first electrode connection region (the predetermined region on the upper surface of the support portion 10) is applied across the predetermined first electrode terminal region in the first electrode of the support-portion-directed piezoelectric element 100 and the first electrode connection region provided on the upper surface of the support portion 10 in a state of covering, in a bridge-like manner, the first insulation adhesive 110 for fixing the support-portion directed piezoelectric element 100 to the predetermined position.

More specifically, the first insulation adhesive 110 is filled in a gap 112 (refer to FIG. 10) between the piezoelectric element 100 and each of the proximal-end-side support portion 11, the distal-end-side support portion 13, and the weak rigidity support portion 15.

The first insulation adhesive 110 filled in the gap 112 may overflow onto an upper surface of the support-portion-directed piezoelectric element 100 and the upper surface of the support portion 10 for some reasons.

In the magnetic head suspension 1, as illustrated in FIG. 9, the first insulation adhesive 110 filled in the gap 112 overflows onto the upper surface of the support-portion-directed piezoelectric element 100 and the upper surface of the support portion 10, and covers a part of the first electrode terminal region and a part of the first electrode connection region (the painted-out portion in FIG. 9).

However, after the first electrode conductive adhesive 120 is applied, as illustrated in FIG. 4, whether the first insulation adhesive 110 covers a part or all of the first electrode terminal region and/or the first electrode connection region cannot be identified.

In other words, even if the first electrode terminal region and the first electrode connection region appear to be appropriately electrically connected by the first electrode conductive adhesive 120 after the first electrode conductive adhesive 120 is applied, there is actually a risk that appropriate electrical connection is not obtained by the first insulation adhesive 110.

In the example illustrated in FIG. 9, only the grid-like hatching region of the first electrode terminal region and only the grid-like hatching region of the first electrode connection region are electrically connected by the first electrode conductive adhesive 120.

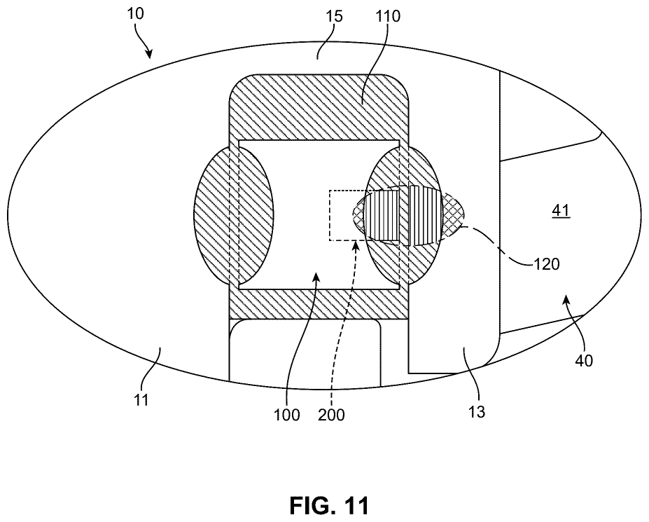

FIG. 11 illustrates a plan view, which corresponds to FIG. 9, of an example in which the first insulation adhesive 110 is excessively applied.

In the example illustrated in FIG. 11, a large part of the first electrode terminal region and a large part of the first electrode connection region (the painted-out portion in FIG. 11) are covered by the first insulation adhesive.

Therefore, even if the first electrode conductive adhesive 120 is appropriately applied, it becomes difficult to obtain appropriate electrical connection between the first electrode terminal region and the first electrode connection region (only the grid-like hatching regions in FIG. 11 are electrically connected).

In consideration of such a problem, the support-portion-directed piezoelectric element fixation processing includes:
a fixation step of fixing the support-portion-directed piezoelectric element 100 to a predetermined mounting position by the first insulation adhesive 110;
an insulation calculation step of calculating an amount of the first insulation adhesive 110 existing on an inspection area 200 set so as to include a part or all of at least one of the first electrode terminal region and the first electrode connection region;
a first electrode electrical connection step of electrically connecting the first electrode terminal region to the first electrode connection region by the first electrode conductive adhesive 120;
a conduction calculation step of calculating an amount of the first electrode conductive adhesive 120 existing on the inspection area 200; and
a determination step of determining electrical connectivity between the first electrode terminal region and the first electrode connection region on the basis of a difference between a calculation value in the conduction calculation step and a calculation value in the insulation calculation step.

As illustrated in FIG. 4 and the like, in the present embodiment, the inspection area 200 is set in a predetermined region of the upper surface of the support-portion-directed piezoelectric element 100 (the first electrode) so as to include a part of the first electrode terminal region.

Instead of this or in addition to this, the inspection area 200 can also be set in a predetermined region of the upper surface of the support portion 10 so as to include a part or all of the first electrode connection region.

The insulation calculation step, the conduction calculation step, and the determination step are performed by using an imaging device (not illustrated) capable of imaging the inspection area 200 and a control device (not illustrated) that receives an image of the inspection area 200 from the imaging device.

In a case where the imaging device is a two-dimensional imaging device, the control device is configured to, in the insulation calculation step, calculate a plane area of a portion covered by the first insulation adhesive 110 in the inspection area 200 (the left-side filled portion in FIG. 9) on the basis of a two-dimensional image of the inspection area 200 captured by the two-dimensional imaging device, in the conduction calculation step, calculate a plane area of a portion covered by the first electrode conductive adhesive 120 in the inspection area 200 (the sum of the left-side painted-out portion and the left-side grid-like hatching portion in FIG. 9) on the basis of the two-dimensional image of the inspection area 200 captured by the two-dimensional imaging device, and, in the determination step, determine the electrical connectivity between the first electrode terminal region and the first electrode connection region on the basis of a difference between the plane area of the first electrode conductive adhesive 120 calculated in the conduction calculation step and the plane area of the first insulation adhesive 110 calculated in the insulation calculation step (the left-side grid-like hatching portion in FIG. 9).

Instead of this, in a case where the imaging device is a three-dimensional imaging device, the control device is configured to, in the insulation calculation step, calculate a volume of the first insulation adhesive 110 existing on the inspection area 200 on the basis of a three-dimensional image of the inspection area 200 captured by the three-dimensional imaging device, in the conduction calculation step, calculate a volume of the first electrode conductive adhesive 120 existing on the inspection area 200 on the basis of the three-dimensional image of the inspection area 200 captured by the three-dimensional imaging device, and, in the determination step, determine the electrical connectivity between the first electrode terminal region and the first electrode connection region on the basis of a difference between the volume of the first electrode conductive adhesive 120 calculated in the conduction calculation step and the volume of the first insulation adhesive 110 calculated in the insulation calculation step.

Preferably, the insulation calculation step and the conduction calculation step are configured to perform imaging by the imaging device in a state in which the inspection area 200 was irradiated with ultraviolet light by an ultraviolet irradiation device (not illustrated).

According to such a configuration, a boundary of the first insulation adhesive 110 and a boundary of the first electrode conductive adhesive 120 in the inspection area 200 can be detected more accurately, and the amount of each adhesive can be calculated accurately.

The inspection area 200 can be set with reference to, for example, a mounting reference point that is used when the support-portion-directed piezoelectric element 100 is mounted at a predetermined position.

According to the manufacturing method according to the present embodiment including the insulation calculation step, the conduction calculation step, and the determination step, the electrical connectivity between the first electrode terminal region and the first electrode connection region in the manufactured magnetic head suspension 1 can be recognized.

As described above, the manufacturing method according to the present embodiment is useful in that shipment of a product having an electrical connection failure between the first electrode terminal region and the first electrode connection region among the manufactured magnetic head suspensions 1 can be prevented. The manufacturing method can be modified to include the fixation step, the insulation calculation step, an application amount calculation step, and a first electrode electrical connection step.

The application amount calculation step is configured to calculate the amount of the first electrode conductive adhesive 120 to be applied for electrically connecting the first electrode terminal region to the first electrode connection region, on the basis of the calculation result in the insulation calculation step.

For example, the control device may store, in advance, data indicating a relationship between the amount of the first insulation adhesive 110 existing on the inspection area 200 and the appropriate amount of the first electrode conductive adhesive 120 to be applied, and calculate the appropriate application amount of the first electrode conductive adhesive 120 by applying the calculation result in the insulation calculation step to the data.

The data is set on the basis of an experiment or the like, and is set such that the larger the amount of the first insulation adhesive 110 existing on the inspection area 200 is, the larger the appropriate application amount of the first electrode conductive adhesive 120 is.

The first electrode electrical connection step in the modified example applies the amount of the first electrode conductive adhesive 120 that calculated in the application amount calculation step to electrically connect the first electrode terminal region to the first electrode connection region.

That is, in the first electrode electrical connection step, the control device operates the discharging device for the first electrode conductive adhesive 120 such that the first electrode conductive adhesive 120 is discharged by the amount calculated in the application amount calculation step.

According to the modified example having such a configuration, for example, when the first insulation adhesive 110 does not exist on the inspection area 200 or the amount of the first insulation adhesive 110 on the inspection area 200 is small, the application amount of the first electrode conductive adhesive 120 can be set to a small initial set amount, and when a large amount of the first insulation adhesive 110 exists on the inspection area 200, the application amount of the first electrode conductive adhesive 120 can be increased from the initial set amount.

Therefore, an electrical connection failure between the first electrode terminal region and the first electrode connection region can be effectively prevented while appropriately controlling the application amount of the first electrode conductive adhesive 120.

Preferably, the manufacturing method according to the modified example can include the conduction calculation step and the determination step after the first electrode electrical connection step.

As described above, in the magnetic head suspension 1, the second electrode (the electrode located on the lower surface on the side closer to the magnetic disk) of the support-portion-directed piezoelectric element 100 is electrically connected to the wiring 734 for support-portion-directed piezoelectric element in the wiring structure 70 of the flexure portion 60 by the second electrode conductive adhesive 125.

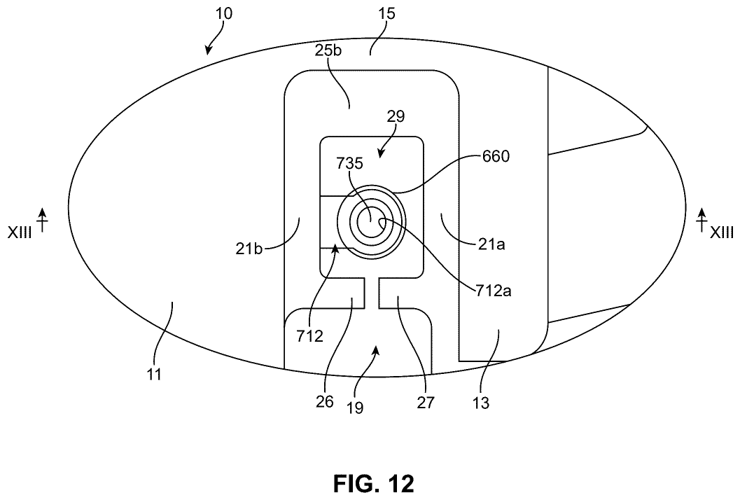

FIG. 12 illustrates a plan view of a state in which the first electrode conductive adhesive 120, the support-portion-directed piezoelectric element 100, and the first insulation adhesive 110 are omitted from FIG. 4.

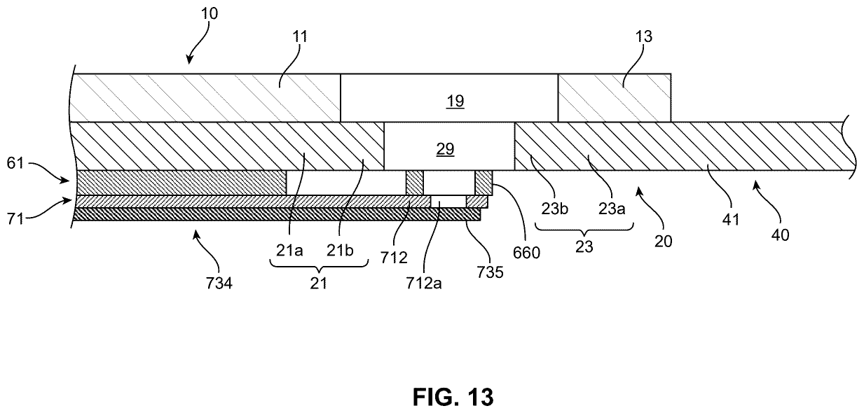

Furthermore, FIG. 13 illustrates a cross-sectional view along a line XIII-XIII in FIG. 12.

As illustrated in FIGS. 3, 12, and 13, the insulation layer 71 of the wiring structure 70 has an extension region 712 extending into the access opening 29 in planar view.

The extension region 712 has a through hole 712a that penetrates the upper surface and the lower surface.

The wiring 734 for support-portion-directed piezoelectric element has a support-portion-directed piezoelectric element terminal region 735 that can be accessed from the upper surface side of the extension region 712 via the through hole 712a.

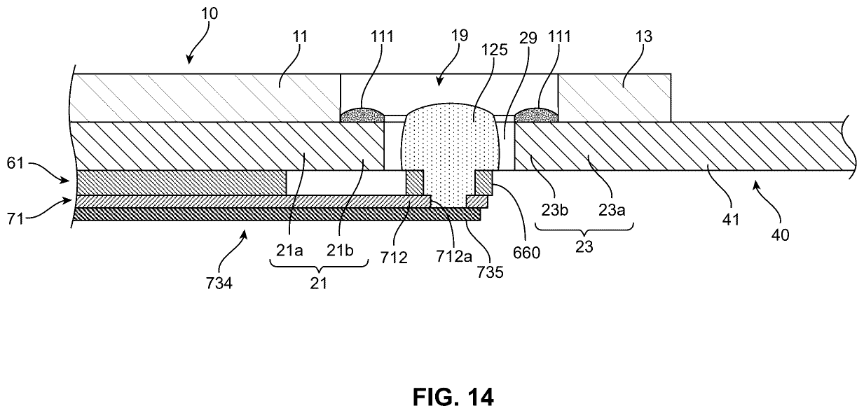

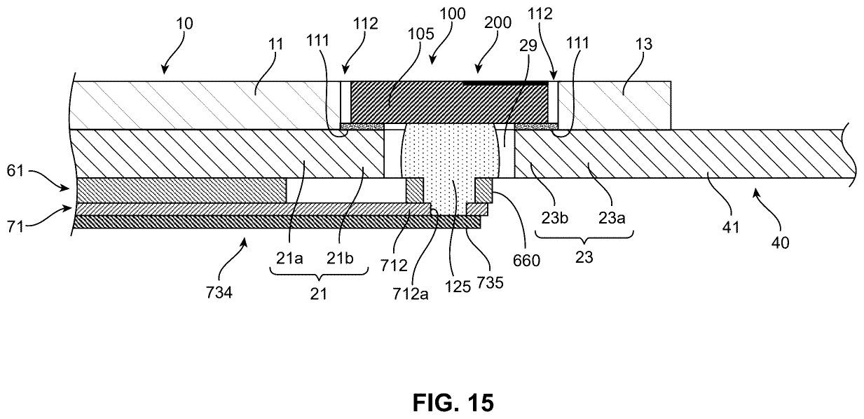

In this case, the support-portion-directed piezoelectric element fixation processing includes a temporary fixation step before the fixation step. In the temporary fixation step, in a state in which the second electrode conductive adhesive 125 is filled in the access opening 29 and the through hole 712a of the extension region 712 such that an upper end is located above an upper surface of the support plate 20, and a second insulation adhesive 111 for temporary fixation is applied to an upper surface (a surface opposite to the disk surface) of the extension region of the support plate 20 (the proximal-end-side extension region 21b, the distal-end-side extension region 23b, and the intermediate extension region 25b in the present embodiment) (refer to FIG. 14), the support-portion-directed piezoelectric element 100 is mounted such that the second electrode of the support-portion-directed piezoelectric element 100 is in contact with the second electrode conductive adhesive 125 and a peripheral region of the lower surface (the surface on the side closer to the disk surface) of the support-portion-directed piezoelectric element 100 is in contact with the second insulation adhesive 111 for temporary fixation (refer to FIG. 15).

The reference numeral 660 in FIGS. 3, 5, and 13 to 15 denotes a ring that is fixed to an upper surface of the insulation layer 71 so as to surround the through hole 712a of the extension region 712 in planar view. The ring prevents the second electrode conductive adhesive 125 filled in the access opening 29 and the through hole 712a from being flown out before being cured.

The support-portion directed piezoelectric element fixation processing is configured to fix, in the fixation step to be performed after the temporary fixation step, the support-portion-directed piezoelectric element 100 at a predetermined position by filling the gap 112 (refer to FIGS. 10 and 15) between the support-portion directed piezoelectric element 100 and each of the proximal-end-side support portion 11, the distal-end-side support portion 13, and the weak rigidity support portion 15 with the first insulation adhesive 110 (refer to FIG. 9).

The support-portion-directed piezoelectric element fixation processing is configured to perform the insulation calculation step, the first electrode electrical connection step, the conduction calculation step, and the determination step in this order after the fixation step.

Next, the flexure-portion-directed piezoelectric element fixation processing will be described.

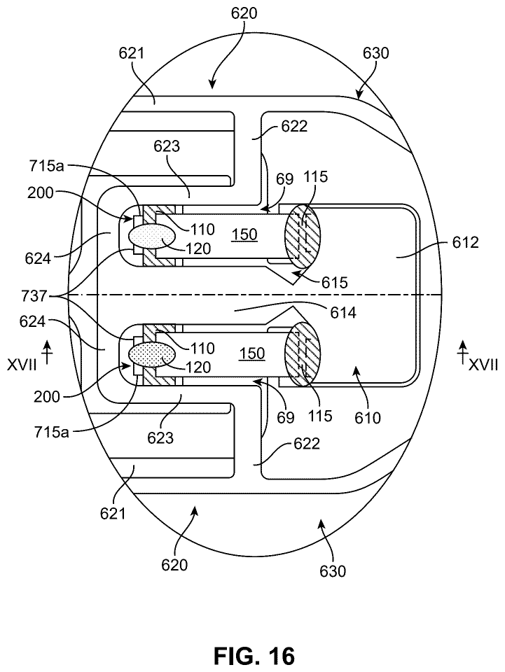

FIG. 16 illustrates a plan view, which corresponds to FIG. 8, of a state in which the load beam portion 50 is omitted.

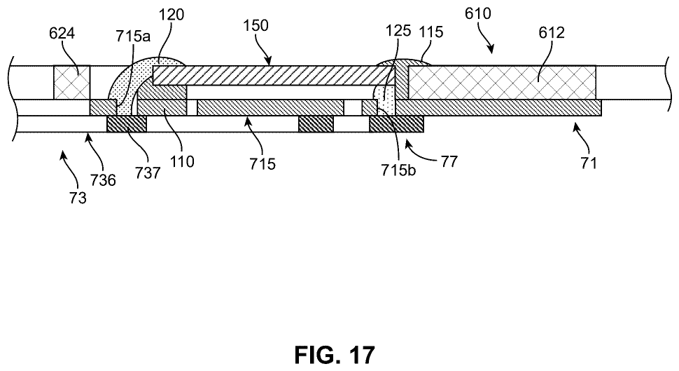

Moreover, FIG. 17 illustrates a cross-sectional view along a line XVII-XVII in FIG. 16.

As illustrated in FIGS. 16 and 17, the flexure-portion-directed piezoelectric element 150 is arranged, in the opening 69 defined by the gimbal region 610 and the pair of gimbal support pieces 620, on an upper surface (a surface opposite to the magnetic disk) of an air region 715, which is described below, of the insulation layer 71 in the wiring structure 70.

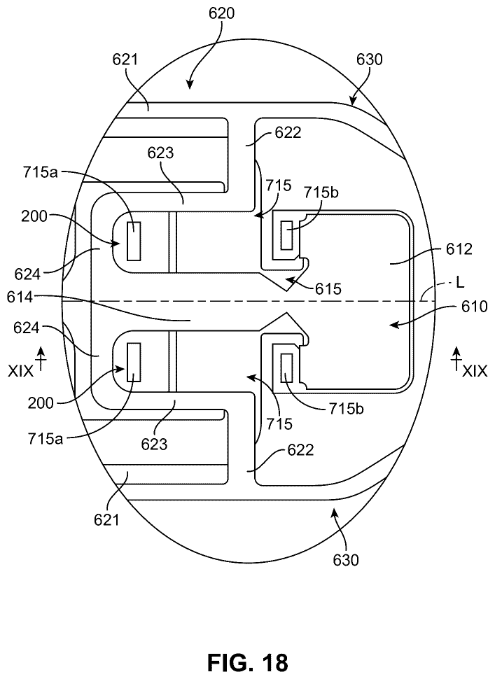

FIG. 18 illustrates a plan view, which corresponds to FIG. 16, of a state in which the flexure-portion-directed piezoelectric elements 150 are omitted.

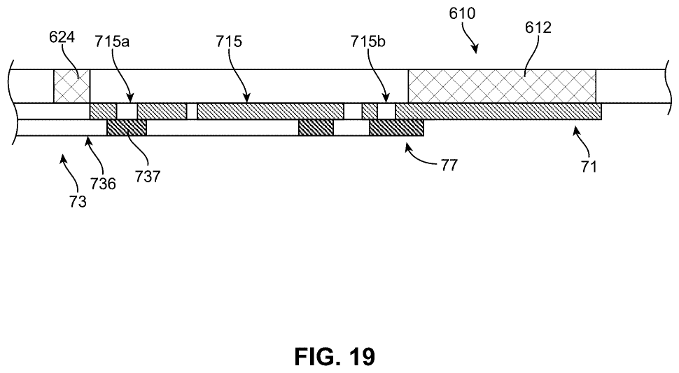

Moreover, FIG. 19 illustrates a cross-sectional view along a line XIX-XIX in FIG. 18.

As described above, the wiring structure 70 has the insulation layer 71 fixed to the lower surface (the surface on the side closer to the magnetic disk) of the flexure substrate 61, and the conductor layer 73 fixed to the lower surface of the insulation layer 71.

As illustrated in FIGS. 18 and 19, the insulation layer 71 has the air region 715 away from a state of being supported by the flexure substrate 61 and extending into the opening 69.

The air region 715 has a first electrode through hole 715a that penetrates the upper surface and the lower surface in the vicinity of a first end portion that is one side in the suspension longitudinal direction of the flexure-portion-directed piezoelectric element 150, and a second electrode through hole 715b that penetrates the upper surface and the lower surface at a position overlapping the flexure-portion-directed piezoelectric element 150 in planar view.

Moreover, the wiring 736 for flexure-portion-directed piezoelectric element in the conductor layer 73 has a flexure-portion piezoelectric element terminal region 737 that can be accessed from above via the first electrode through hole 715a.

Furthermore, the wiring structure 70 has a ground metallic portion 77 (refer to FIGS. 3 and 17 and the like) provided on the lower surface of the insulation layer 71 in a state of being insulated from the conductor layer 73 and being accessible from above via the second electrode through hole 715b.

The ground metallic portion 77 is preferably formed of the same material as the conductor layer 73, and is formed simultaneously when the conductor layer 73 is formed on the lower surface of the insulation layer 71.

In the magnetic head suspension 1 having such a configuration, a region of the flexure-portion piezoelectric element terminal region 737, which is exposed via the first electrode through hole 715a, forms the first electrode connection region of the flexure-portion-directed piezoelectric element 150, and the ground metallic portion 77 forms a second electrode connection region to which a second electrode of the flexure-portion-directed piezoelectric element 150 is electrically connected.

The flexure-portion-directed piezoelectric element fixation processing includes a second electrode electrical connection step and a piezoelectric element second end portion fixation step in addition to the fixation step, the insulation calculation step, the first electrode electrical connection step, the conduction calculation step, and the determination step.

The second electrode electrical connection step is performed in parallel with the fixation step.

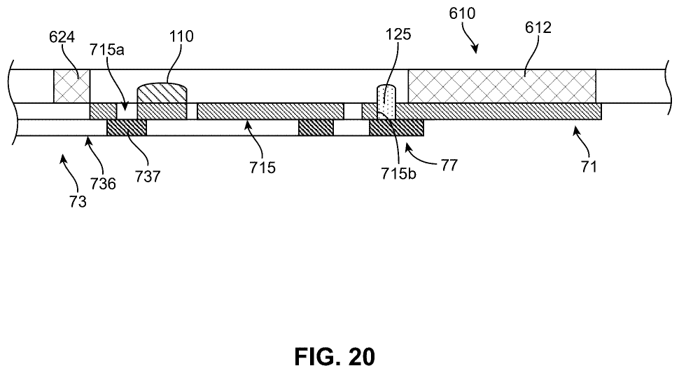

FIG. 20 illustrates a cross-sectional view, which corresponds to FIG. 19, of a state in the middle of the fixation step and the second electrode electrical connection step which are performed in parallel.

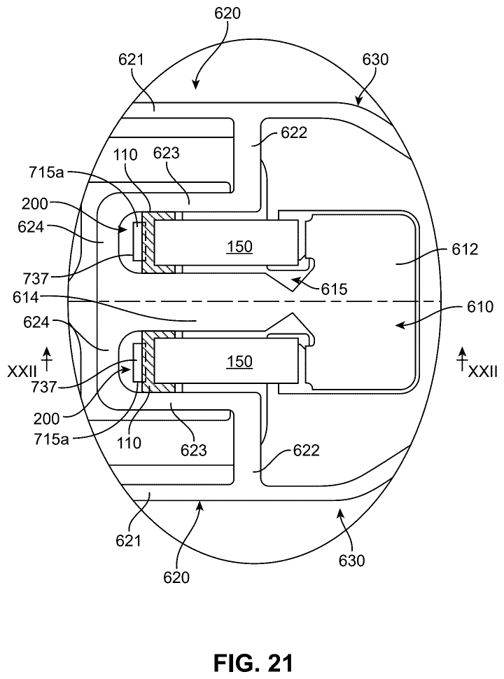

Moreover, FIG. 21 illustrates a plan view, which corresponds to FIGS. 16 and 18, of a state in which the fixation step and the second electrode electrical connection step have been completed.

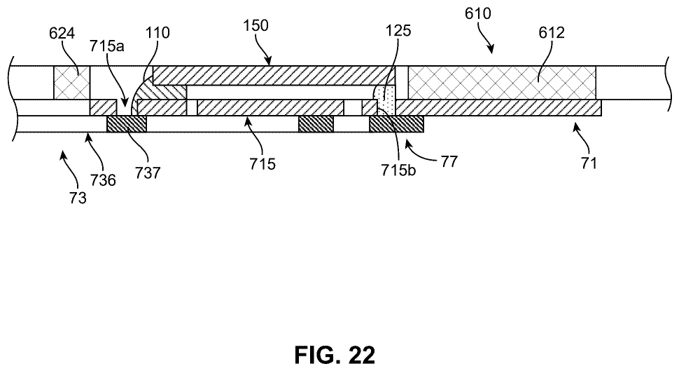

FIG. 22 illustrates a cross-sectional view along a line XXII-XXII in FIG. 21.

More specifically, in the fixation step of the flexure-portion-directed piezoelectric element fixation processing, the first insulation adhesive 110 is applied to a portion of the upper surface of the air region 715, on which the first end portion in the longitudinal direction of the flexure-portion-directed piezoelectric element 150 is to be placed (refer to FIG. 20), and then, the flexure-portion-directed piezoelectric element 150 is mounted such that the first end portion in the longitudinal direction of the flexure-portion-directed piezoelectric element 150 is in contact with the first insulation adhesive 110.

In the second electrode electrical connection step, the second electrode through hole 715b whose lower-surface-side opening is closed by the ground metallic portion 77 is filled with the second electrode conductive adhesive 125 (refer to FIG. 20), and then, the flexure-portion-directed piezoelectric element 150 is mounted on the air region 715.

That is, the fixation step and the second electrode electrical connection step which are performed in parallel are configured so as to apply the first insulation adhesive 110 on the upper surface of the air region 715 and fill the second electrode through hole 715b with the second electrode conductive adhesive 125, and then mount the flexure-portion-directed piezoelectric element 150 at a predetermined position of the upper surface of the air region 715, so that the flexure-portion-directed piezoelectric element 150 is fixed to the upper surface of the insulation layer 71 by the first insulation adhesive 110 while the second electrode being electrically connected to the ground metallic portion 77 that acts as a ground conductive region (refer to FIG. 22).

In the magnetic head suspension 1, as illustrated in FIGS. 18, 21, and 22, the whole of the first electrode connection region (that is, the region of the flexure-portion piezoelectric element terminal region 737, which is exposed via the first electrode through hole 715a) is set as the inspection area 200, and the first insulation adhesive 110 covers a part of the inspection area 200.

Therefore, in the flexure-portion directed piezoelectric element fixation processing, the insulation calculation step, which is performed after the fixation step and the second electrode electrical connection step, calculates the amount of the first insulation adhesive 110 located on the region of the flexure-portion piezoelectric element terminal region 737, which is exposed via the first electrode through hole 715a.

The piezoelectric element second end portion fixation step, which is performed at an appropriate timing after the second electrode electrical connection step, is configured so as to fix a second end portion in the longitudinal direction of the flexure-portion-directed piezoelectric element 150 to the wide portion 612 of the gimbal region 610 by another second insulation adhesive 115 (refer to FIGS. 16 and 17).

1. An inspection method of electrical connectivity of an piezoelectric element, the inspection method being applied in manufacturing a magnetic head suspension including the piezoelectric element that finely moves a gimbal region to which a magnetic head slider is mounted in a seek direction parallel to a disk surface, wherein the piezoelectric element is fixed to a predetermined mounting position by a first insulation adhesive, and wherein a predetermined first electrode terminal region of a first electrode, which is disposed on one side in a thickness direction of the piezoelectric element, is electrically connected to a predetermined first electrode connection region by a first electrode conductive adhesive covering the first insulation adhesive in a bridge-like manner, the inspection method comprising:
an insulation calculation step of calculating, after fixing the piezoelectric element to the predetermined mounting position by the first insulation adhesive, an amount of the first insulation adhesive existing on an inspection area set so as to include a part or all of at least one of the first electrode terminal region and the first electrode connection region;
a conduction calculation step of calculating, after electrically connecting the first electrode terminal region to the first electrode connection region by the first electrode conductive adhesive, an amount of the first electrode conductive adhesive existing on the inspection area; and
a determination step of determining electrical connectivity between the first electrode terminal region and the first electrode connection region on a basis of a difference between a calculation value in the conduction calculation step and a calculation value in the insulation calculation step.

2. The inspection method of electrical connectivity of the piezoelectric element according to claim 1, wherein the inspection area is set with reference to a mounting reference point for the piezoelectric element.

3. The inspection method of electrical connectivity of the piezoelectric element according to claim 1,
wherein the insulation calculation step and the conduction calculation step each are configured to calculate a plane area of a portion covered by the corresponding adhesive in the inspection area on the basis of a two-dimensional image of the inspection area captured by a two-dimensional imaging device, and
wherein the determination step is configured to determine the electrical connectivity between the first electrode and the first electrode connection region on the basis of a difference between the plane area of the first electrode conductive adhesive calculated in the conduction calculation step and the plane area of the first insulation adhesive calculated in the insulation calculation step.

4. The inspection method of electrical connectivity of the piezoelectric element according to claim 1,
wherein the insulation calculation step and the conduction calculation step each are configured to calculate a volume of the corresponding adhesive existing on the inspection on the basis of a three-dimensional image of the inspection area captured by a three-dimensional imaging device, and
wherein the determination step is configured to determine the electrical connectivity between the first electrode and the first electrode connection region on the basis of a difference between the volume of the first electrode conductive adhesive calculated in the conduction calculation step and the volume of the first insulation adhesive calculated in the insulation calculation step.

5. The inspection method of electrical connectivity of the piezoelectric element according to claim 3, wherein the insulation calculation step and the conduction calculation step each are configured to perform imaging by the imaging device in a state in which the inspection area was irradiated with ultraviolet light by an ultraviolet irradiation device.

6. A manufacturing method of a magnetic head suspension including a piezoelectric element that finely moves a gimbal region to which a magnetic head slider is mounted in a seek direction parallel to a disk surface, wherein the piezoelectric element is fixed to a predetermined mounting position by a first insulation adhesive, and wherein a predetermined first electrode terminal region of a first electrode, which is disposed on one side in a thickness direction of the piezoelectric element, is electrically connected to a predetermined first electrode connection region by a first electrode conductive adhesive covering the first insulation adhesive in a bridge-like manner, the manufacturing method comprising:
a fixation step of fixing the piezoelectric element to the predetermined mounting position by the first insulation adhesive;
an insulation calculation step of calculating an amount of the first insulation adhesive existing on an inspection area set so as to include a part or all of at least one of the first electrode terminal region and the first electrode connection region;
a first electrode electrical connection step of applying the first electrode conductive adhesive by a predetermined amount to electrically connect the first electrode terminal region to the first electrode connection;
a conduction calculation step of calculating an amount of the first electrode conductive adhesive existing on the inspection area; and
a determination step of determining electrical connectivity between the first electrode and the first electrode connection region on a basis of a difference between a calculation value in the conduction calculation step and a calculation value in the insulation calculation step.

7. A manufacturing method of a magnetic head suspension including a piezoelectric element that finely moves a gimbal region to which a magnetic head slider is mounted in a seek direction parallel to a disk surface, wherein the piezoelectric element is fixed to a predetermined mounting position by a first insulation adhesive, and wherein a predetermined first electrode terminal region of a first electrode, which is disposed on one side in a thickness direction of the piezoelectric element, is electrically connected to a predetermined first electrode connection region by a first electrode conductive adhesive covering the first insulation adhesive in a bridge-like manner, the manufacturing method comprising:
a fixation step of fixing the piezoelectric element to the predetermined mounting position by the first insulation adhesive;
an insulation calculation step of calculating an amount of the first insulation adhesive existing on an inspection area set so as to include a part or all of at least one of the first electrode terminal region and the first electrode connection region;
an application amount calculation step of calculating an amount of the first electrode conductive adhesive to be applied for electrically connecting the first electrode terminal region to the first electrode connection region, on a basis of the calculation result in the insulation calculation step; and
a first electrode electrical connection step of applying the amount of the first electrode conductive adhesive that is calculated in the application amount calculation step to electrically connect the first electrode terminal region to the first electrode connection region.

8. The manufacturing method of the magnetic head suspension according to claim 7, further comprising:
a conduction calculation step of calculating an amount of the first electrode conductive adhesive existing on the inspection area; and
a determination step of determining electrical connectivity between the first electrode and the first electrode connection region on the basis of a difference between a calculation value in the conduction calculation step and a calculation value in the insulation calculation step.

9. The manufacturing method of the magnetic head suspension according to claim 6, wherein the inspection area is set with reference to a mounting reference point that is used when the piezoelectric element is mounted at the predetermined position.

10. The manufacturing method of the magnetic head suspension according to claim 6, wherein the calculation steps each are configured to calculate a plane area of a portion covered by the corresponding adhesive in the inspection area on the basis of a two-dimensional image of the inspection area captured by a two-dimensional imaging device.

11. The manufacturing method of the magnetic head suspension according to claim 6, wherein the calculation steps each are configured to calculate a volume of the corresponding adhesive existing on the inspection on the basis of a three-dimensional image of the inspection area captured by a three-dimensional imaging device.

12. The manufacturing method of the magnetic head suspension according to claim 10, wherein the insulation calculation step and the conduction calculation step are configured to perform imaging by the imaging device in a state in which the inspection area was irradiated with ultraviolet light by an ultraviolet irradiation device.

13. The manufacturing method of the magnetic head suspension according to claim 6,
wherein the magnetic head suspension includes a support portion that is directly or indirectly swung about a swing center in the seek direction parallel to the disk surface by a main actuator, a load bending portion that includes a leaf spring having a proximal end portion connected to the support portion and generating a load for pressing the gimbal region against the disk surface, a load beam portion that is supported by the support portion via the load bending portion and transmits the load to the gimbal region, and a flexure portion that includes a flexure substrate including the gimbal region and a wiring structure fixed to the flexure substrate,
wherein the support portion includes a proximal-end-side support portion having the swing center, a distal-end-side support portion that supporting the proximal end side of the load bending portion, and a weak-rigidity support portion connecting the distal-end-side support portion and the proximal-end-side support portion such that the distal-end-side support portion can swing to both sides in the seek direction with respect to the proximal-end-side support portion with reference to a suspension longitudinal direction center line, the weak-rigidity support portion being provided with openings that enable the pair of piezoelectric elements to be arranged symmetrically to each other with respect to the longitudinal direction center line,
wherein the magnetic head suspension further includes a support plate fixed to a lower surface of the support portion, the support plate supporting the lower surfaces of the pair of piezoelectric elements while having access openings for exposing parts of lower surfaces of the pair of piezoelectric elements to the disk surface side,
wherein the wiring structure includes an insulation layer provided on the lower surface of the flexure substrate that faces the disk surface, and a conductor layer provided on the insulation layer,
wherein the insulation layer has an extension region extending into the access opening in planar view,
wherein the conductor layer includes a signal wiring electrically connected to the magnetic head slider and a piezoelectric element wiring for supplying a driving voltage to the piezoelectric element, the piezoelectric element wiring having has a piezoelectric element terminal region arranged in the extension region,
wherein a second electrode of the piezoelectric element that is disposed on the other side in the thickness direction of the piezoelectric element is electrically connected to the piezoelectric element terminal region via a second electrode conductive adhesive filled in the access opening and a through hole formed in the extension region,
wherein the manufacturing method further includes a temporary fixation step performed before the fixation step, the temporary fixation step is configured to apply the second electrode conductive adhesive in the access opening and the through hole and apply a second insulation adhesive for temporary fixation to the support plate, and then mount the piezoelectric element such that the second electrode of the piezoelectric element is in contact with the second electrode conductive adhesive and a peripheral region of the lower surface of the piezoelectric element is in contact with the second insulation adhesive for temporary fixation,
wherein the fixation step is configured to apply the first insulation adhesive in gaps between the piezoelectric element and the proximal-end-side support portion, the distal-end-side support portion and the weak-rigidity support portion, and
wherein the inspection area is set at the first electrode the support portion.

14. The manufacturing method of the magnetic head suspension according to claim 6,
wherein the magnetic head suspension includes a support portion that is directly or indirectly swung about a swing center in the seek direction parallel to the disk surface by a main actuator, a load bending portion that includes a leaf spring having a proximal end portion connected to the support portion and generating a load for pressing the gimbal region against the disk surface, a load beam portion that is supported by the support portion via the load bending portion and transmits the load to the gimbal region, and a flexure portion that includes a flexure substrate including the gimbal region and a wiring structure fixed to the flexure substrate,
wherein the flexure substrate includes a load-beam-portion fixation region overlapped with and fixed to the load beam portion, and a flexure distal end region extending from the load-beam-portion fixation region to the distal end side so as to be free from a state of being supported by the load beam portion,
wherein the flexure distal end region has the gimbal region and a pair of gimbal support pieces, the gimbal region having an upper surface opposite to the disk surface with which a dimple provided in the load beam portion is in contact and a lower surface facing the disk surface that supports the magnetic head slider, the pair of gimbal support pieces extending from the load-beam-portion fixation region toward the distal end side in the suspension longitudinal direction in a state of being symmetrical to each other with reference to the suspension longitudinal direction center line and supporting the gimbal region such that the gimbal region can swing in a roll direction and the seek direction with the dimple as a fulcrum,
wherein the gimbal region and the pair of gimbal support pieces are configured to form openings that enable the pair of piezoelectric elements to be arranged symmetrically to each other with respect to the suspension longitudinal direction center line,
wherein the gimbal region is provided with a weak rigidity portion that enables the gimbal region to swing to both sides in the seek direction with the dimple as a fulcrum in response to expansion and contraction operation of the pair of piezoelectric elements,
wherein the wiring structure includes an insulation layer provided on the lower surface of the flexure substrate that faces the disk surface, and a conductor layer provided on a lower surface of the insulation layer,
wherein the insulation layer has an air region that is away from a state of being supported by the flexure substrate and extends into the opening,
wherein the conductor layer includes a signal wiring electrically connected to the magnetic head slider and a piezoelectric element wiring for supplying a driving voltage to the piezoelectric element,
wherein the piezoelectric element wiring has a piezoelectric element terminal region arranged in the air region,
wherein the wiring structure further includes a ground metallic portion provided on the lower surface of the air region in a state of being insulated from the conductor layer,
wherein the air region has a first electrode through hole and a second electrode through hole that cause the piezoelectric element terminal region and the ground metallic portion to be exposed to the upper surface of the insulation layer, respectively,
wherein a region of the piezoelectric element terminal region that is exposed via the first electrode through hole forms the first electrode connection region,
wherein a second electrode of the piezoelectric element that is disposed on the other side in the thickness direction of the piezoelectric element is electrically connected to the ground metallic portion via a second electrode conductive adhesive filled in the second electrode through hole,
wherein the manufacturing method further includes a second electrode electrical connection step performed in parallel with the fixation step and a piezoelectric element second end portion fixation step performed at an appropriate timing after the second electrode electrical connection step,
wherein the fixation step and the second electrode electrical connection step that are performed in parallel are configured so as to apply the first insulation adhesive to an area of the upper surface of the air region on which a first end portion in the longitudinal direction of the piezoelectric element is mounted and apply the second electrode conductive adhesive in the second electrode through hole, and then mount the piezoelectric element on the upper surface of the air region so that the first end portion of the piezoelectric element is fixed to the upper surface of the air region while the second electrode is electrically connected to the ground conductive region,
wherein the piezoelectric element second end portion fixation step is configured so as to fix a second end portion in the longitudinal direction of the piezoelectric element to the gimbal region by another second insulation adhesive, and
wherein the inspection area is set to the region of the piezoelectric element terminal region that is exposed via the first electrode through hole.
